(19) United States
(12) Patent Application Publication
(10) Pub. No.: US 2009/0307043 A1
(43) Pub. Date: Dec. 10, 2009

(54) METHOD AND SYSTEM FOR PATTERN BASED SCHEDULING

(76) Inventor: PETER CHOLEWINSKI, St. Leon-Rot (DE)

Correspondence Address: SAP AG, 3410 HILLVIEW AVENUE, PALO ALTO, CA, 94304, US

(21) Appl. No.: 12/134,224

(22) Filed: Jun. 6, 2008

(51) Int. Cl. G06F 9/46

(52) U.S. Cl. 705/9

(57) ABSTRACT

Disclosed is a method and system for receiving a scheduling input parameter for an event, analyzing the scheduling input parameter to determine a schedule pattern and generating a list of schedules for the event based on the schedule pattern. The list of schedules includes a recurring schedule and a non-recurring schedule for the event.

### FIELD OF THE INVENTION

The invention generally relates to the field of scheduling events in an application and specifically to pattern based scheduling.

### BACKGROUND OF THE INVENTION

Current scheduling applications typically have limited capabilities for creating a schedule for recurring events. The scheduling applications typically do not provide flexibility to schedule recurring events that recur at different times at different recurrences. For example, consider scheduling a meeting on every Monday. The user may want to have the meeting from 10:00 AM to 11:00 AM on even Mondays and from 14:00 to 15:00 on odd Mondays. The scheduling applications allows the user to either schedule the meeting from 10:00 AM to 11:00 AM on every Monday or from 14:00 to 15:00 on every Monday but not with different times on even Mondays and odd Mondays. The current scheduling applications are typically not capable of scheduling events with complex recurring patterns. The scheduling applications typically do not offer a feature such as proposing a list of schedules for the event based on a date and time input by the user for the event.

The scheduling applications are less user friendly, especially for scheduling a recurring event. The process of creating a schedule for a recurring event may involve a number of steps making it time consuming, difficult, tedious and thus inefficient. Furthermore, changing an already scheduled recurring event is tedious and sometimes not possible in many scheduling applications. Also, the current scheduling applications may not support scheduling a variety of events such as meetings, tasks, and batch jobs within a single scheduling application.

### SUMMARY OF THE INVENTION

What is described is a method and system for receiving a scheduling input parameter for an event, analyzing the scheduling input parameter to determine a schedule pattern and generating a list of schedules for the event based on the schedule pattern. The list of schedules includes a recurring schedule and a non-recurring schedule for the event.

### BRIEF DESCRIPTION OF THE DRAWINGS

FIG. 1 is a flow diagram for generating a list of schedules for an event according to an embodiment of the invention.

FIG. 2 is a flow diagram for analyzing a scheduling input parameter according to an embodiment of the invention.

FIG. 3 is an example screen display of a scheduling tool according to an embodiment of the invention.

FIG. 4 is an example screen display of a scheduling tool to schedule an event with multiple start dates according to an embodiment of the invention.

FIG. 5 is a block diagram of a system for generating a list of schedules for an event according to an embodiment of the invention.

### DETAILED DESCRIPTION

What is described is a method and system for receiving a scheduling input parameter for an event, analyzing the scheduling input parameter to determine a schedule pattern and generating a list of schedules for the event based on the scheduling pattern. The list of schedules includes a recurring schedule and a non-recurring schedule for the event.

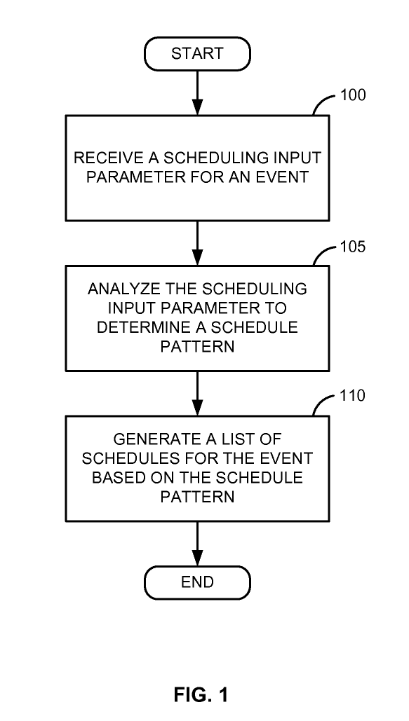

FIG. 1 is a flow diagram for generating a list of schedules for an event according to an embodiment of the invention. At step 100, a scheduling input parameter for an event is received. The scheduling input parameter contains a start date, an end date, a start time, an end time and a recurrence count for the event. At step 105, the scheduling input parameter is analyzed to determine a schedule pattern. At step 110, a list of schedules is generated for the event based on the scheduling input parameter and the schedule pattern. The list of schedules includes a recurring schedule for the event and a non-recurring schedule for the event.

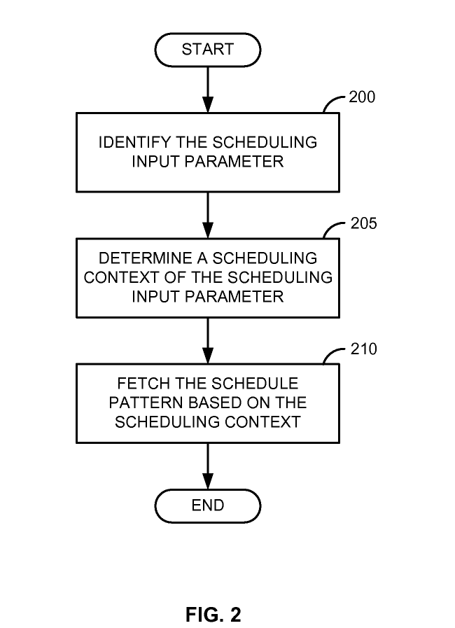

FIG. 2 is a flow diagram for analyzing a scheduling input parameter according to an embodiment of the invention. At step 200, parameters such as a start date, an end date, a start time, an end time, a recurrent count, and number of start dates contained in the scheduling input parameter are identified. A list of schedules for the event is generated based on the parameters contained in the scheduling input parameter. For example, if the scheduling input parameter contains an end date for a recurring event, a schedule where the event recurs from the start date to the end date is generated in the list of schedules. In another embodiment, if the scheduling input parameter does not contain the end date, a schedule where the event recurs infinitely from the start date is generated in the list of schedules. In another embodiment, if the scheduling input parameter contains the recurrence count, a schedule where the event recurs as many times as the recurrence count may be generated in the list of schedules.

At step 205, a scheduling context of the scheduling input parameter is determined. The scheduling context determines a context such as whether the start date is a weekend, a first day of the month, a first day of the week, a last Friday of the week, and a last day of the month. In an embodiment, if the scheduling input parameter contains a start date such as “Monday, 4^{th} July” then the scheduling context of the start date may be determined as “first day of the week”, “first Monday of the month”, “4^{th} day of the month”, and “July 4^{th} ”. In another embodiment, the scheduling input parameter may contain two start dates “Monday, July 4^{th} ” and “Thursday, July 7^{th} ”. The scheduling context for the scheduling input parameter may be determined as “Monday and Thursday of the week”, “4^{th} and 7^{th} of the month”, “first Monday and first Thursday of the month”, and “July 4^{th} and July 7^{th} ”.

After, the scheduling context of the scheduling input parameter is determined, at step 210, a scheduling pattern for the scheduling context is obtained. The scheduling pattern includes recurring schedule patterns and non-recurring schedule patterns. The recurring schedule patterns may include patterns such as “every X_DAY of TM_PRD from ST_TM to END_TM”, where
X includes values “first”, “second”, “third”, “last” and dates of the month such as “1^{st}”, “2^{nd}” and “3^{rd}”.
DAY includes values such as “business day”, days of the week such as “Monday”, “Tuesday”, and “holiday”.
“TM_PRD” denotes a time period and includes values such as “day”, “week”, “fortnight”, “month”, “quarter”, and “year”.
“ST_TM” denotes a start time of the event.
“END_TM” denotes an end time of the event.

In another embodiment, recurring schedule pattern includes more than one start date such as “every X_DAY of TM_PRD from ST_TM to END_TM and Y_DAY of TM_PRD from ST_TM to END_TM”, “every X_DAY starting from Y_DAY from ST_TM to END_TM”, and “every X_DAY of TM_PRD to Y_DAY of TM_PRD from ST_TM to END_TM”. The scheduling pattern may include non-recurring schedule pattern where in the event occurs only once at a specified date and time such as “X_DAY of TM_PRD from ST_TM to END_TM”.

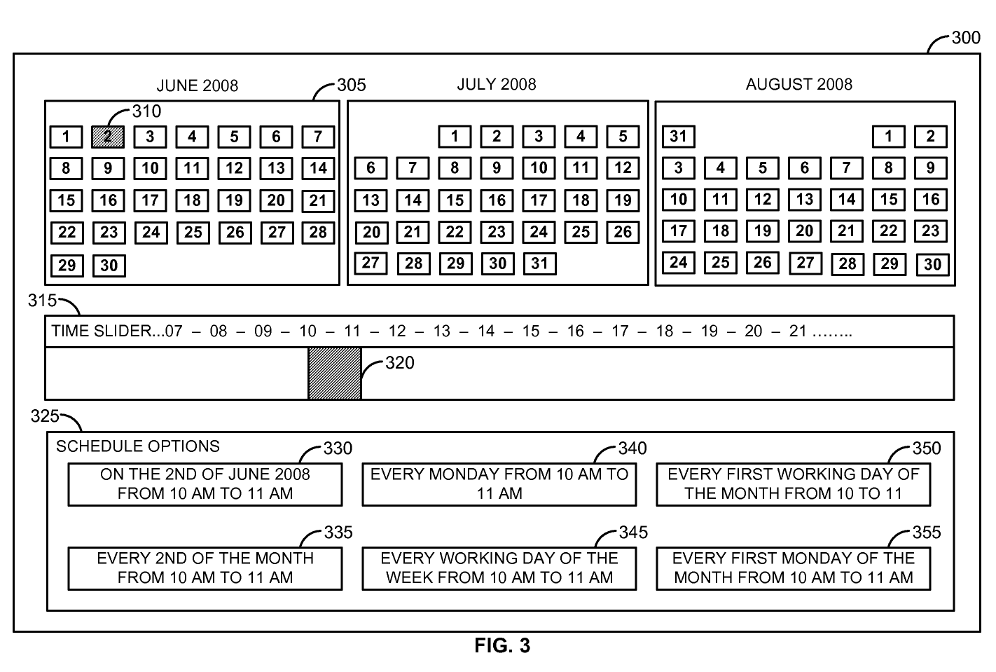

FIG. 3 is an example screen display of a scheduling tool according to an embodiment of the invention. Scheduling tool 300 allows a user to schedule an event by selecting event date 310 and event time 320. The event date 310 may be selected from calendar 305 and event time 320 from time slider 315. The event date 310 indicates a date on which the event occurs and event time 320 indicates a time span of the event, that is, a start time and an end time of the event. The schedule options 325 displays a list of schedules generated for the event by scheduling tool 300.

The user provides a scheduling input parameter by selecting event date 310 and event time 320. Scheduling tool 300 identifies event date 310 as a start date with a value of “Monday, 2^{nd} Jun. 2008” and event time 320 as two input parameters, namely, a start time with a value of “10:00 AM” and an end time with a value of “11:00 AM”. Scheduling tool 300 analyzes the scheduling input parameter to determine a schedule pattern. A scheduling context of event date 310 “Monday, 2^{nd} Jun. 2008” may include but not limited to values such as “2^{nd} Jun. 2008”, “first working day of the week”, “first working day of the month”, “first Monday of the month”, “second day of a month”, and “second day of the week”.

The scheduling pattern for the event is obtained based on the scheduling context. The scheduling pattern includes a non-recurring schedule pattern such as “X_DAY of TM_PRD from ST_TM to END_TM” and a recurring schedule pattern such as “every X_DAY of TM_PRD from ST_TM to END_TM”. The recurring schedule pattern is a scheduling pattern for recurring events. Further, the schedule pattern is mapped with the scheduling input parameter and the scheduling context to generate a list of schedules for the event as displayed in schedule options 325.

The list of schedules includes a non-recurring schedule such as first schedule 330 and recurring schedules such as second schedule 335, third schedule 340, fourth schedule 345, fifth schedule 350, and sixth schedule 355 for the event. The first schedule 330 indicates that the event occurs on “2ND OF JUN. 2008 FROM 10 AM TO 11 AM”. The second schedule 335 indicates that the event occurs “EVERY 2ND OF THE MONTH FROM 10 AM TO 11 AM”. The third schedule 340 indicates that the event occurs “EVERY MONDAY FROM 10 AM TO 11 AM”. The fourth schedule 345 indicates that the event occurs “EVERY WORKING DAY OF THE WEEK FROM 10 AM TO 11 AM”. The fifth schedule 350 indicates that the event occurs “EVERY FIRST WORKING DAY OF THE MONTH FROM 10 AM TO 11 AM”. The sixth schedule 355 indicates that the event occurs “EVERY FIRST MONDAY OF THE MONTH FROM 10 AM TO 11 AM”. In another embodiment, the list of schedules may include other recurring schedules for the event. The user may choose a schedule from the list of schedules. In an embodiment, the user may also provide an end date for the event. The end date may be same as the start date or a different date. For example, an event may start on “Monday, 2^{nd} Jun. 2008 10:00 AM” and end on “Thursday, 5^{th} Jun. 2008 17:00”. In an embodiment, the user may provide an end date for recurring schedules of the event. In another embodiment, the user may provide a recurrence count for the recurring schedules of the event which defines a number of times the event may recur.

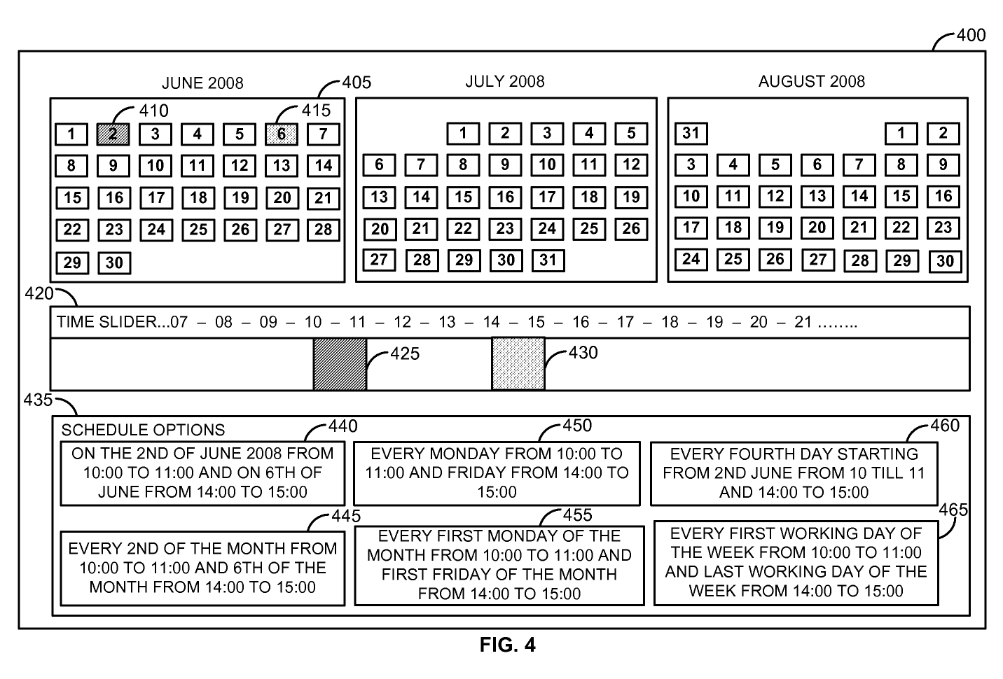

FIG. 4 is an example screen display of a scheduling tool to schedule an event with multiple start dates according to an embodiment of the invention. The scheduling tool 400 allows a user to schedule an event on more than one day, that is, an event with more than one start date. Consider a scenario where the user wants to schedule the event on two days, first on “2^{nd} Jun. 2008 from 10:00 AM to 11:00 AM” and second on “6^{th} Jun. 2008 from 14:00 to 15:00”. A scheduling input parameter for the event may consist of at least four parameters including first start date 410, second start date 415, first time span 425 and second time span 430. The first start date 410 with a value of “Monday, 2^{nd} Jun. 2008” and second start date 415 with a value of “6^{th} Jun. 2008” may be selected from calendar 405. The first time span 425 with a value of “10:00 AM to 11:00 AM” for first start date 410 and second time span 430 with a value of “14:00 to 15:00” for second start date 415 may be selected from time slider 420. In an embodiment, second time span 430 may be same as first time span 425. In an embodiment, first start date 410, first time span 425 may be visually distinguished from second start date 415 and second time span 430 by a color code. In another embodiment with multiple start dates, a time span for a particular start date may be provided by double clicking on the start date.

Various parameters contained in the scheduling input parameter are identified and analyzed based on a scheduling context. The scheduling context of first date 410 “Monday, 2^{nd} Jun. 2008” and second date 415 “Friday, 6^{th} Jun. 2008” is determined as “2^{nd} and 6^{th} of a month”, “Monday and Friday of a week”, “first Monday of the month and first Friday of the month”, “fourth day starting from 2^{nd} of a month”, and “first working day of the week and last working day of the week”. In another embodiment, the scheduling context may include other such values.

Scheduling patterns “X_DAY and Y_DAY of TM_PRD from ST_TM to END_TM”, “every X_DAY from ST_TM to END_TM and Y_DAY of TM_PRD from ST_TM to END_TM” and “every X_DAY starting from Y_DAY from ST_TM to END_TM” are obtained based on the scheduling context. The scheduling pattern is mapped with the scheduling input parameter and the scheduling context to generate a list of schedules for the event. The list of schedules including first schedule 440, second schedule 445, third schedule 450, fourth schedule 455, fifth schedule 460, and sixth schedule 465 are displayed in scheduling options 435. The user may choose a schedule from the list of schedules. After choosing a schedule from the list of schedules, the user may further customize the schedule of the event. In an embodiment, the schedule may be customized by changing a time of the event on a particular occurrence. The scheduling tool 400 may be configured to sort the list of schedules based on a frequency of a schedule selected by the user. In other words, the most selected schedule may appear first in the list and the least selected schedule may appear last in the list. In an embodiment, this is made possible by persisting a schedule pattern chosen by the user in a storage unit.

Further, the scheduling tool 400 may also be used to schedule certain events like batch jobs which are triggered for execution at a particular time. The batch jobs typically have a start time but no end time. The batch jobs may be scheduled in the scheduling tool 400 by specifying only the start time in time slider 420. The scheduling tool 400 may also be used to generate a list of schedules when a particular resource such as a meeting room and projector is available to be used.

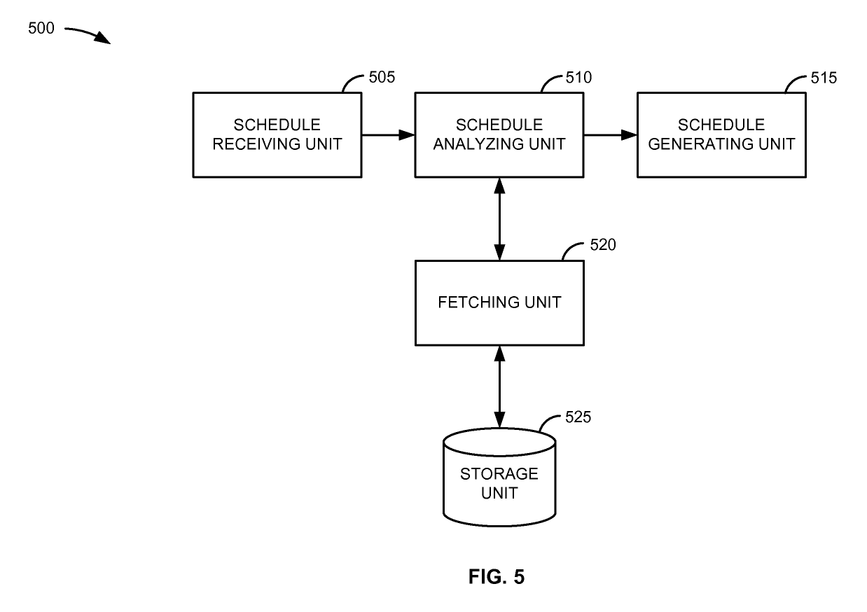

FIG. 5 is a block diagram of a system for generating a list of schedules for an event according to an embodiment of the invention. System 500 includes schedule receiving unit 505 to receive a scheduling input parameter for an event. A schedule analyzing unit 510 connected to schedule receiving unit 505 analyzes the scheduling parameter to determine a schedule pattern. The schedule analyzing unit 510 identifies parameters in the scheduling input parameter, determines the scheduling context of the scheduling parameter and obtains a scheduling pattern from storage unit 525 via fetching unit 520 connected to storage unit 525. In an embodiment, storage unit 525 includes a database. In an embodiment, fetching unit 520 may also be used to persist a schedule pattern in storage unit 525. A schedule generating unit 515 connected to schedule analyzing unit receives the scheduling input parameter, the scheduling context and the scheduling pattern from schedule analyzing unit 510. The schedule generating unit 515 maps the scheduling input parameter with the scheduling context and the scheduling pattern to generate a list of schedules for the event. The list of schedules includes non-recurring schedule and recurring schedule for the event.

Embodiments of the invention may include various steps as set forth above. The steps may be embodied in machine-executable program code which causes a general-purpose or special-purpose processor to perform certain steps. Alternatively, these steps may be performed by specific hardware components that contain hardwired logic for performing the steps, or by any combination of programmed computer components and custom hardware components. A general-purpose computer includes a processor, memory, and other conventional hardware. As one skilled in the art will appreciate, the methods or systems described above can be implemented in program code that is executed by the processor to accomplish the described functions.

Embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or any other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A method, comprising:
receiving a scheduling input parameter for an event;
analyzing the scheduling input parameter to determine a schedule pattern; and
generating a list of schedules for the event based on the schedule pattern.

2. The method in claim 1, wherein analyzing the scheduling input parameter to determine a schedule pattern comprises:
identifying the scheduling input parameter;
determining a scheduling context of the scheduling input parameter; and
fetching the schedule pattern based on the scheduling context.

3. The method in claim 1, wherein generating a list of schedules comprises mapping the schedule pattern with the scheduling input parameter and the scheduling context.

4. The method in claim 1, wherein the scheduling input parameter comprises a parameter selected from a group consisting of a start date, a start time, an end date, an end time and a recurrence count.

5. The method in claim 2, wherein the scheduling context comprises a context parameter selected from a group consisting of a weekend, alternate days, every third day, a first day of the month, a first day of the week, a last Friday of the month, a last day of the month, and a last hour of the day.

6. The method in claim 1, wherein the schedule pattern comprises a pattern selected from a group consisting of a recurring schedule pattern and a non-recurring schedule pattern.

7. The method in claim 1, wherein generating a list of schedules comprises generating a schedule with a start time and an end time if the scheduling input parameter contains the start time and the end time.

8. The method in claim 1, wherein generating a list of schedules comprises generating a schedule with a start time if the scheduling input parameter contains the start time and no end time.

9. The method in claim 1, wherein generating a list of schedules comprises generating a recurring schedule with a start date and an end date if the scheduling input parameter contains the end date.

10. The method in claim 9 further comprising generating a recurring schedule for the event where a number of times the event recurs is defined by a recurrence count contained in the scheduling input parameter.

11. The method in claim 1, wherein generating a list of the schedules comprises generating a recurring schedule with a variable start time on different recurrences.

12. The method in claim 1, further comprising storing a schedule pattern that is selected by a user in a storage unit.

13. The method in claim 1, further comprising customizing a schedule in the list of schedules based on a parameter selected from a group consisting of a start date, an end date, a start time, an end time and a recurrence count.

14. A system, comprising:
a schedule receiving unit to receive a scheduling input parameter for an event;
a schedule analyzing unit electronically coupled to the schedule receiving unit to analyze the scheduling input parameter to determine a schedule pattern; and
a schedule generating unit electronically coupled to the schedule analyzing unit to generate a list of schedules for the event based on the schedule pattern.

15. The system in claim 14, further comprising a fetching unit electronically coupled to the schedule analyzing unit to fetch the schedule pattern.

16. The system in claim 14, further comprising a storage unit electronically coupled to the fetching unit to persist the schedule pattern.

17. An article of manufacture, comprising:
a machine readable medium having instructions which when executed by a machine cause the machine to:
receive a scheduling input parameter for an event;
analyze the scheduling input parameter to determine a schedule pattern; and
generate a list of schedules for the event based on the schedule pattern.

18. The article of manufacture in claim 17, wherein the machine readable medium provides instructions, which when executed by a machine cause the machine to
identify the scheduling input parameter;
determine a scheduling context of the scheduling input parameter; and
fetch the schedule pattern based on the scheduling context.

19. The article of manufacture in claim 17, wherein the machine readable medium provides instructions, which when executed by a machine cause the machine to generate a recurring schedule pattern with a variable start time on different recurrences.

20. The article of manufacture in claim 17, wherein the machine readable medium provides instructions, which when executed by a machine cause the machine to map the schedule pattern with the scheduling input parameter and the scheduling context.
